(19) United States
(12) Patent Application Publication
(10) Pub. No.: US 2008/0148322 A1
(43) Pub. Date: Jun. 19, 2008

(54) System and method of providing video-on-demand content

(75) Inventor: Jerald Robert Howcroft, Beverly Hills, MI (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/640,816

(22) Filed: Dec. 18, 2006

(51) Int. Cl. H04N 7/173

(52) U.S. Cl. 725/87

(57) ABSTRACT

The present disclosure is directed to a system and method for distributing video-on-demand content. In an embodiment, a method is disclosed that includes receiving data at a server of a first multimedia service provider. The received data identifies a multimedia program available from a second multimedia service provider as video-on-demand (VOD) content. Program guide data is sent to a multimedia receiver to display an indication that the multimedia program is available as VOD content concurrently with displaying an indication that the multimedia program is available as a scheduled program.

### FIELD OF THE DISCLOSURE

The present disclosure relates generally to providing video-on-demand content.

### BACKGROUND

Many people enjoy viewing scheduled multimedia content such as broadcast television programming. Electronic program guides typically enable viewers to view a schedule of current and future programming and to select a program to view. However, viewers may desire to view a program after the scheduled broadcast. Video-on-demand content catalogs are typically provided on dedicated channels that must be searched by a user to find desired content. Hence, there is a need for an improved system and method of providing video-on-demand content.

### BRIEF DESCRIPTION OF THE DRAWINGS

FIG. 1 is a block diagram of a particular illustrative embodiment of a system to provide video-on-demand content;

FIG. 2 is a block diagram of a second particular illustrative embodiment of a system to provide video-on-demand content;

FIG. 3 is a flow diagram of a particular illustrative embodiment of a method of providing video-on-demand content;

FIG. 4 is a flow diagram of a second particular illustrative embodiment of a method of providing video-on-demand content;

FIG. 5 is a diagram of an embodiment of a graphical user interface to provide video-on-demand content;

FIG. 6 is a flow diagram of a third particular illustrative embodiment of a method of providing video-on-demand content; and

FIG. 7 is a diagram of an embodiment of a general computer system.

### DETAILED DESCRIPTION OF THE DRAWINGS

In a particular embodiment, a system to provide video-on-demand content is disclosed. The system includes a server to provide video-on-demand (VOD) content to a first multimedia service provider from a second multimedia service provider. The server has a processor and a memory device accessible to the processor. The memory device includes instructions to send data identifying a plurality of multimedia programs to a channel content guide server of the first multimedia service provider. A first multimedia program is distributed by the first multimedia service provider as a scheduled program. The memory device also includes instructions to receive a request from the channel content guide server to provide the first multimedia program as VOD content to a set-top box device (STB). The request is received in response to a selection of the first multimedia program at the STB after the scheduled program has ended.

In another embodiment, a set-top box device is disclosed that includes a processor and a memory device coupled to the processor. The memory device includes instructions to display a graphical user interface (GUI). The GUI includes a first program schedule that displays current and future scheduled programming available from a first multimedia service provider. The GUI also includes a second program schedule that displays past scheduled programming of the first multimedia service provider. Each program displayed in the second program schedule indicates video-on-demand (VOD) accessibility when the program is available as VOD content from a second multimedia service provider.

In another embodiment, a method of providing video-on-demand content is disclosed. The method includes receiving video-on-demand (VOD) availability data at a server of a first multimedia service provider, the VOD availability data identifying a multimedia program available from a second multimedia service provider as VOD content. The method also includes sending program guide data to a multimedia receiver. The program guide data causes the multimedia receiver to display an indication that the multimedia program is available as VOD content concurrently with displaying an indication that the multimedia program is available as a scheduled program of the first multimedia service provider.

In another embodiment, a second method of providing video-on-demand content is disclosed. The method includes sending a program guide to a display device, the program guide indicating that a multimedia program is available as a scheduled program of a first multimedia service provider and concurrently indicating that the multimedia program is available as video-on-demand (VOD) content. The method also includes receiving a selection of the multimedia program. The method also includes sending a request to a second multimedia service provider to receive the multimedia program as VOD content.

In another embodiment, a processor-readable medium tangibly embodying processor instructions is disclosed. The processor instructions include instructions to receive program scheduling data from a channel content server. The program scheduling data identifies a first plurality of multimedia programs and associated program schedule times. The processor instructions also include instructions to receive video-on-demand (VOD) availability data from a VOD server. The VOD availability data identifies a second plurality of multimedia programs that are accessible as VOD content. The processor instructions further include instructions to identify a multimedia program that is in the first plurality of multimedia programs and that is also in the second plurality of multimedia programs. The processor instructions also include instructions to store program guide data associating the multimedia program with the associated program schedule time and also associating the multimedia program with a VOD indicator.

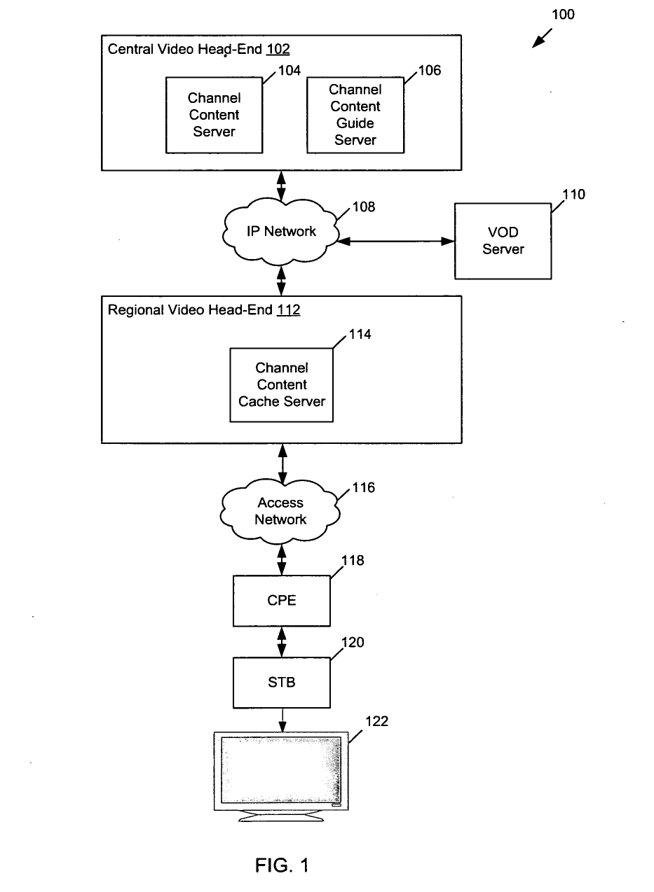

Referring to FIG. 1, a block diagram of a particular illustrative embodiment of a system to provide video-on-demand (VOD) content is depicted and generally designated 100. The system 100 includes a Central Video Head-End (VHE) 102 of a first multimedia service provider, such as an Internet Protocol Television (IPTV) content provider. The system 100 also includes a VOD server 110 of a second multimedia service provider, such as a VOD content aggregator, communicating with the Central VHE 102 via an Internet Protocol (IP) network 108. The VOD server 110 also communicates with a representative Regional VHE 112 via the IP network 108. The system 100 further includes a multimedia receiver, such as a representative set-top box device (STB) 120, communicating with the Regional VHE 112 via an access network 116, such as an IPTV access network.

In a particular embodiment, the Central VHE 102 can include a channel content server 104 that can store, format, encode, replicate, or otherwise manipulate or prepare multimedia content to provide scheduled programming to subscribers. In a particular embodiment, the channel content server 104 can send data to the channel content guide server 106 that identifies scheduled multimedia programs and scheduling information. In a particular embodiment, the channel content server 104 can receive a request for multimedia content from the STB 120 and can send the requested multimedia content to the STB 120. In an illustrative embodiment, the channel content server 104 can transmit the requested multimedia content to the STB 120 via IP multicast.

In a particular embodiment, the Central VHE 102 can include a channel content guide server 106 that can communicate with the channel content server 104 and can receive, process, store, and distribute data that identifies multimedia programs and associated program scheduling information. In a particular embodiment, the channel content guide server 106 can receive data from the channel content server 104 that identifies scheduled multimedia programs and scheduling information and can store the received data as electronic program guide (EPG) data. The channel content guide server 106 can also receive data from the VOD server 110 that identifies available VOD content. In a particular embodiment, the channel content guide server 106 can identify one or more multimedia programs that are available from both the channel content server 104 and the VOD server 110 and can store an indication in the EPG data that the multimedia program is available as VOD content. In a particular embodiment, the channel content guide server can provide the EPG data to the STB 120.

In a particular embodiment, the VOD server 110 can store VOD content, VOD metadata, other VOD data such as a catalog of available VOD content, or any combination thereof. In a particular embodiment, the VOD server 110 can communicate data identifying available VOD content to the channel content guide server 106 via the IP network 108. In a particular embodiment, the VOD server 110 can receive a request for VOD content and send the requested VOD content to the STB 120. In a particular illustrative embodiment, the VOD server 110 can send the requested VOD content to the STB 120 via the IP network 108 and the access network 116. In another particular illustrative embodiment, the VOD server 110 can send the requested VOD content to the STB 120 via a channel content cache server 114.

In a particular embodiment, the Central VHE 102 can communicate with one or more Regional Video Distribution or Head-Ends, such as the representative Regional VHE 112, via the IP network 108. The IP network 108 can include a public IP network, a private IP network, or any combination thereof. In a particular embodiment, the Regional VHE 112 can include one or more channel content cache servers 114 to receive data such as multimedia content for distribution to the STB 120. In an illustrative embodiment, the channel content cache server 114 can process, replicate, and store at least a portion of the multimedia content prior to distribution to users. In a particular embodiment, the channel content cache server 114 can cache VOD data received from the VOD server 110 and can send the cached VOD data to the STB 120. In a particular embodiment, one or more channel content cache servers 114 can be located at the Central VHE 102, at one or more Regional VHEs 112, or any combination thereof.

In a particular embodiment, the Central VHE 102 and the Regional VHE 112 can distribute multimedia content to user equipment via the access network 116. In an illustrative embodiment, customer premises equipment (CPE) 118 can be coupled to a local switch, router, or other device of the access network 116. The CPE 118 can include routers, local area network devices, modems, such as digital subscriber line (DSL) modems, any other suitable devices for facilitating communication between a STB 120 and the access network 116, or any combination thereof. Although a single representative STB 120 is illustrated in FIG. 1, it should be understood that multiple set-top box devices can receive multimedia content via the access network 116.

In an exemplary embodiment, the STB 120 can be coupled to the Regional VHE 112, the Central VHE 102, or any combination thereof, via fiber-optic cables. In another exemplary embodiment, the CPE 118 can include a DSL modem that is coupled to one or more network nodes via twisted pairs, and the Regional VHE 112, the Central VHE 102, or any combination thereof, can be coupled to the network nodes via fiber-optic cables. The STB 120 can process data received via the access network 116 via an IPTV software platform, such as Microsoft® TV IPTV Edition.

The STB 120 can be coupled to an external display device, such as a television monitor 122. The STB 120 can include an IPTV set-top box device, a video gaming device or console that is adapted to receive IPTV content, a personal computer or other computing device that is adapted to emulate set-top box device functionalities, any other device adapted to receive IPTV content and transmit data to an IPTV system via an access network, or any combination thereof.

In an exemplary, non-limiting embodiment, the STB 120 can receive data, video, or any combination thereof, via the access network 116 and render or display the data, video, or any combination thereof, at the display device 122 to which it is coupled. In an illustrative embodiment, the STB 120 can include one or more tuners that receive and decode television programming signals or packet streams for transmission to the display devices 122.

In a particular embodiment, STB 120 can receive EPG data from the channel content guide server 106 and can display the EPG data at the display device 122. In an illustrative embodiment, the STB 120 can display current and future programming information at the display device 122 that can include multimedia programs, such as television programs, that are available at a current time or that will be available at a future time from the channel content server 104. In another illustrative embodiment, the STB 120 can display historical programming information at the display device 122 that can include scheduled multimedia programs, such as television programs, that are no longer available from the channel content server 104. The STB 120 can display an indication for each historical multimedia program that is available from the VOD server 110.

In an illustrative embodiment, the STB 120 can receive a selection command from a user of the STB 120 that indicates a particular multimedia program from the displayed EPG data. In a particular illustrative embodiment, the STB 120 can send a request to the channel content server 106 to receive the selected multimedia program when the selected multimedia program is available from the channel content server 104 as a current or future scheduled program. In another particular illustrative embodiment, the STB 120 can send the request to the VOD server 110 when the selected multimedia program is a historical scheduled program that is available as VOD content.

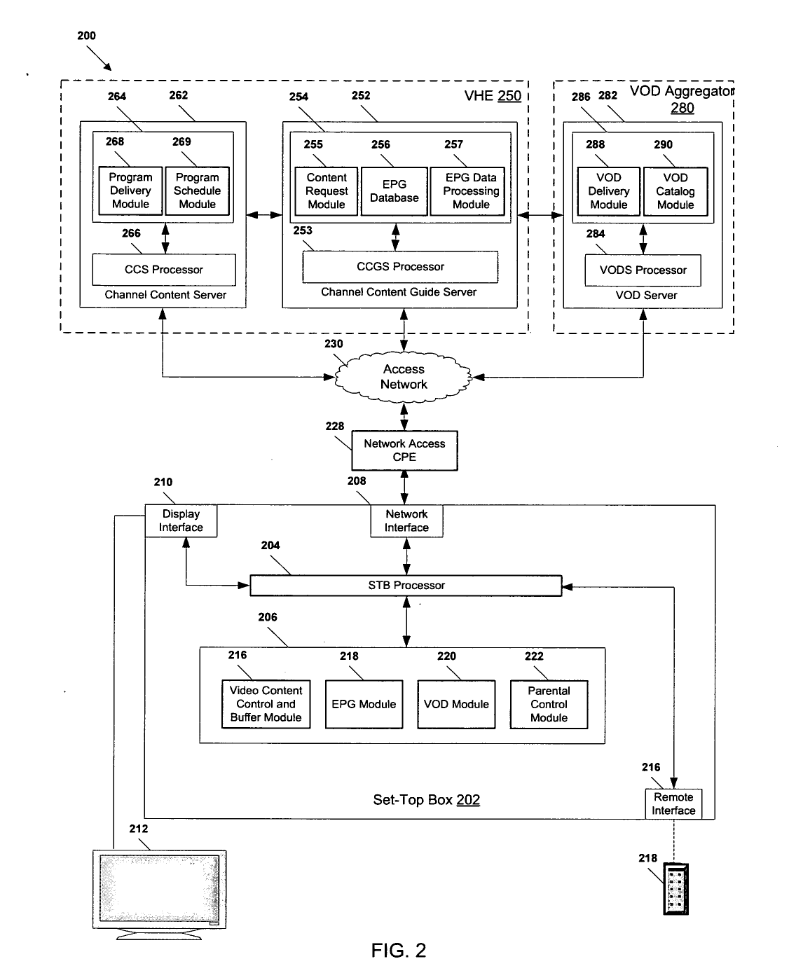

Referring to FIG. 2, a block diagram of a second particular illustrative embodiment of a system to provide video-on-demand (VOD) content is depicted and generally designated 200. The system 200 includes a set-top box device (STB) 202 communicating with a channel content guide server 252 at a video head-end (VHE) 250 of a first multimedia content provider, such as an Internet Protocol Television (IPTV) content provider. The STB 202 communicates with the channel content guide server via an access network 230, such as an IPTV access network. The system 200 also includes a channel content server 262 at the VHE 250 communicating with the STB 202 via the access network 230. The system 200 also includes a VOD server 282 of a second multimedia service provider, such as a VOD content aggregator 280, communicating with the STB 202 via the access network 230. In a particular embodiment, the VOD content aggregator 280 only provides VOD content and does not provide scheduled multimedia programming to subscribers of the IPTV content provider.

In a particular embodiment, the STB 202 can include a STB processor 204 and a memory device 206 that is accessible to the STB processor 204. The STB processor 204 can be coupled to a network interface 208 that enables the STB 202 to communicate with the access network 230 via a network access customer premises equipment (CPE) 228. Further, the STB processor 204 can be coupled to a remote interface 216 that enables the STB 202 to receive commands from a remote control device 218. In addition, the STB processor 204 can be coupled to a display interface 210 that enables the STB 202 to send multimedia content to a display device 212.

In a particular embodiment, the memory device 206 can include a video content control and buffer module 216 that is executable by the STB processor 204 to process video content that is received from the channel content server 262 and the VOD server 282 to display at the display device 212. In addition, the video content control and buffer module 216 can buffer received video content to prevent underflow.

In a particular embodiment, the memory device 206 can include an electronic program guide (EPG) module 218 that is executable by the STB processor 204 to provide program guide information. The EPG module 218 can store program guide data that is received from the channel content guide server 252 and can include formatting instructions for displaying the program guide data at the display device 212. In a particular embodiment, the EPG module 218 can include instructions to display a schedule of current and future multimedia programs that are available from the IPTV content provider. The EPG module 218 can also include instructions to display a schedule of historical scheduled multimedia programs provided by the IPTV content provider. In a particular embodiment, the EPG module 218 can also include instructions to concurrently display an indication that a scheduled multimedia program is available as VOD content when the multimedia program is available from the VOD content aggregator 280. The EPG module 218 can include instructions to provide a navigable and selectable program guide graphical user interface (GUI) to display the multimedia program schedules and VOD content indication at the display device 212. The program guide GUI can be responsive to navigation and selection instructions received from the remote control device 218 or other input devices coupled to the STB 202.

In a particular embodiment, the memory device 206 can include a VOD module 220 that is executable by the STB processor 204 to receive data associated with VOD content. In a particular embodiment, the VOD module 220 can track a progress of VOD content download from the VOD server 282. The VOD module 220 can include instructions to display an indication when the download is complete. In another particular embodiment, the VOD module 220 can track a progress of VOD content received as a hypertext transport protocol (HTTP) progressive download from the VOD server 282. The VOD module 220 can include instructions to display an indication that the VOD program can begin playing at the display device 212 when a sufficient portion of the VOD content has been received.

In a particular embodiment, the memory device 206 can include a parental control module 222 that is executable by the STB processor 204 to maintain and enforce one or more viewing content control policies. The parental control module 222 can compare data associated with a requested program, such as rating data that indicates adult content or violence, to the viewing content control policies. In an illustrative embodiment, the parental control module 222 can include instructions to prompt a user of the STB 202 for identification information, such as a password, when a request for restricted content is received. In another illustrative embodiment, the parental control module 222 can deny a request for restricted content based on the viewing content control policies.

In a particular illustrative embodiment, the STB 202 can receive commands from a user of the STB 202 via the remote control device 218 to navigate to and select a multimedia program via the program guide GUI. The STB 202 can send a request to the channel content guide server 252 for the selected multimedia program. The STB 202 can receive the selected multimedia program as IP multicast content from the channel content server 262 via the access network 230 when the scheduled program time for the multimedia program has not ended. If the multimedia program is selected after the scheduled program time has ended, such as when the program is selected from a schedule of historical programming, the STB 202 can receive the selected program as IP unicast content from the VOD server 282 via the access network 230.

In a particular embodiment, the channel content guide server 252 can include a channel content guide server (CCGS) processor 253 and a memory device 254 that is accessible to the CCGS processor 253. In an illustrative embodiment, the memory device 254 can include a content request module 255 that is executable by the CCGS processor 253 to receive and process a request for multimedia content from the STB 202. In a particular embodiment, an electronic program guide (EPG) database 256 can store and maintain scheduled programming information. In an illustrative embodiment, the memory device 254 can include an EPG data processing module 257 that executable by the CCGS processor 253 to receive, process, store and update data at the EPG database 256.

In a particular embodiment, the channel content server 262 can include a channel content server (CCS) processor 266 and a memory device 264 that is accessible to the CCS processor 266. In an illustrative embodiment, the memory device 264 can include a program delivery module 268 that is executable by the CCS processor 266 to receive, process, and deliver scheduled multimedia programs. In an illustrative embodiment, the memory device 264 can include a program schedule module 269 that is executable by the CCS processor 266 to store and maintain data associated with scheduled multimedia programming. In an illustrative embodiment, the program schedule module 269 can send program schedule data to the channel content guide server 252 indicating scheduled multimedia programs and program scheduling information.

In a particular embodiment, the VOD server 282 can include a VOD server (VODS) processor 284 and a memory device 286 that is accessible to the VODS processor 284. In an illustrative embodiment, the memory device 286 can include a VOD delivery module 288 that is executable by the VODS processor 284 to receive a request from the channel content guide server 252 for a VOD program that was selected by a user of the STB 202 after a scheduled program time at the channel content server 262 has ended. The VOD delivery module 288 can initiate delivery of the requested VOD program by streaming the requested VOD content to the STB 202 via the access network 230. In an illustrative embodiment, the memory device 286 can include a VOD catalog module 290 that is executable by the VODS processor 284 to maintain and provide information associated with VOD content available from the VOD content source 280 to the channel content guide server 252.

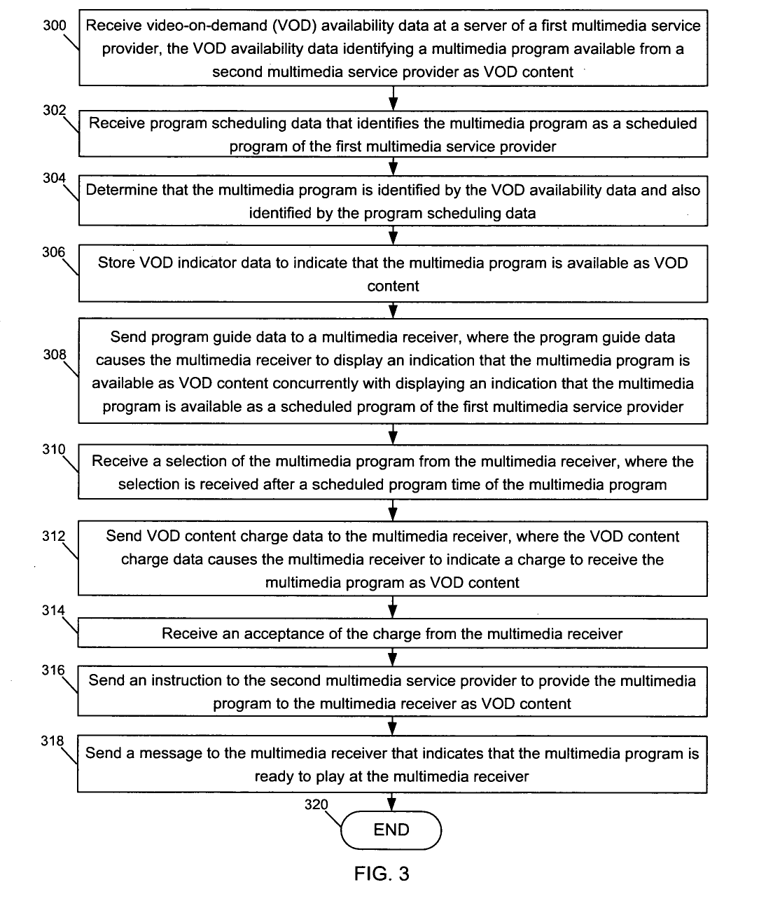

Referring to FIG. 3, a flow diagram of a particular illustrative embodiment of a method of providing video-on-demand content is depicted. At block 300, video-on-demand (VOD) availability data is received at a server of a first multimedia service provider, the VOD availability data identifying a multimedia program available from a second multimedia service provider as VOD content. In a particular embodiment, the first multimedia service provider can be a television service provider, such as an Internet Protocol Television (IPTV) service provider that uses Internet Protocol (IP) multicast to provide scheduled program content. In a particular embodiment, the second multimedia service provider can be a VOD content aggregator that uses IP unicast to provide VOD content.

Moving to block 302, in a particular embodiment, program scheduling data that identifies the multimedia program as a scheduled program of the first multimedia service provider is received. Continuing to block 304, in a particular embodiment, the multimedia program is determined to be identified by the VOD availability data and also identified by the program scheduling data. Proceeding to block 306, in a particular embodiment, VOD indicator data is stored to indicate that the multimedia program is available as VOD content.

Moving to block 308, program guide data is sent to a multimedia receiver, where the program guide data causes the multimedia receiver to display an indication that the multimedia program is available as VOD content concurrently with displaying an indication that the multimedia program is available as a scheduled program of the first multimedia service provider. In a particular embodiment, the multimedia program can be indicated as available as VOD content after a scheduled program time of the multimedia program but can be not indicated as available as VOD content before the scheduled program time. Thus, subscribers can be encouraged to view multimedia programs at scheduled program times to ensure advertising content is delivered and to reduce use of network resources providing VOD content.

Continuing to block 310, in a particular embodiment, a selection of the multimedia program can be received from the multimedia receiver after a scheduled program time of the multimedia program. Proceeding to block 312, in a particular embodiment, VOD content charge data can be sent to the multimedia receiver, where the VOD content charge data causes the multimedia receiver to indicate a charge to receive the multimedia program as VOD content.

Moving to block 314, in a particular embodiment, an acceptance of the charge can be received from the multimedia receiver. Continuing to block 318, in a particular embodiment, an instruction can be sent to the second multimedia service provider to provide the multimedia program to the multimedia receiver as VOD content. Proceeding to block 318, in a particular embodiment, a message can be sent to the multimedia receiver that indicates that the multimedia program is ready to play at the multimedia receiver. The method terminates at 320.

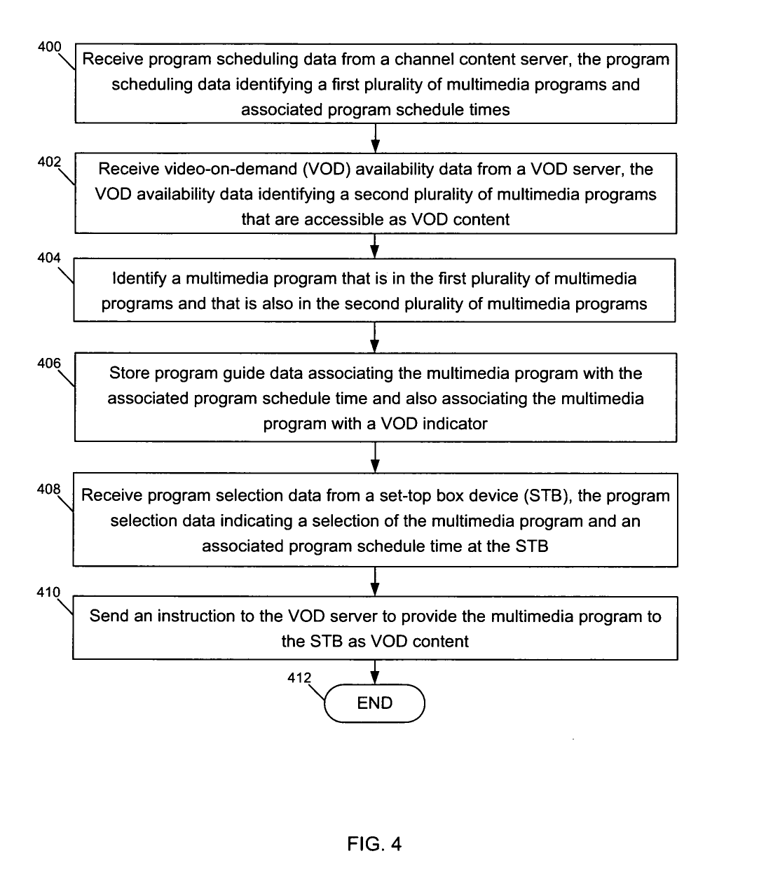

Referring to FIG. 4, a flow diagram of a second particular illustrative embodiment of a method of distributing video-on-demand (VOD) content is depicted. At block 400, program scheduling data is received from a channel content server, the program scheduling data identifying a first plurality of multimedia programs and associated program schedule times. In an illustrative embodiment, the program scheduling data can include information for an electronic program guide (EPG).

Moving to block 402, video-on-demand (VOD) availability data is received from a VOD server, the VOD availability data identifying a second plurality of multimedia programs that are accessible as VOD content. In a particular embodiment, the first plurality of multimedia programs can be made available to a first set of subscribers by a first multimedia service provider, and the second plurality of multimedia files can be provided by a second multimedia service provider that does not provide scheduled multimedia programming to the first set of subscribers.

Continuing to block 404, a multimedia program is identified that is in the first plurality of multimedia programs and that is also in the second plurality of multimedia programs. Proceeding to block 406, program guide data associating the multimedia program with the associated program schedule time and also associating the multimedia program with a VOD indicator is stored. In an illustrative embodiment, information from the program guide database can be sent to one or more set-top box devices to display via an EPG application that can be executed at the set-top box devices.

Advancing to block 408, in a particular embodiment, program selection data can be received from the set-top box device (STB), the program selection data indicating a selection of the multimedia program and an associated program schedule time at the STB. Moving to block 410, in a particular embodiment, an instruction can be sent to the VOD server to provide the multimedia program to the STB as VOD content. The method terminates at 412.

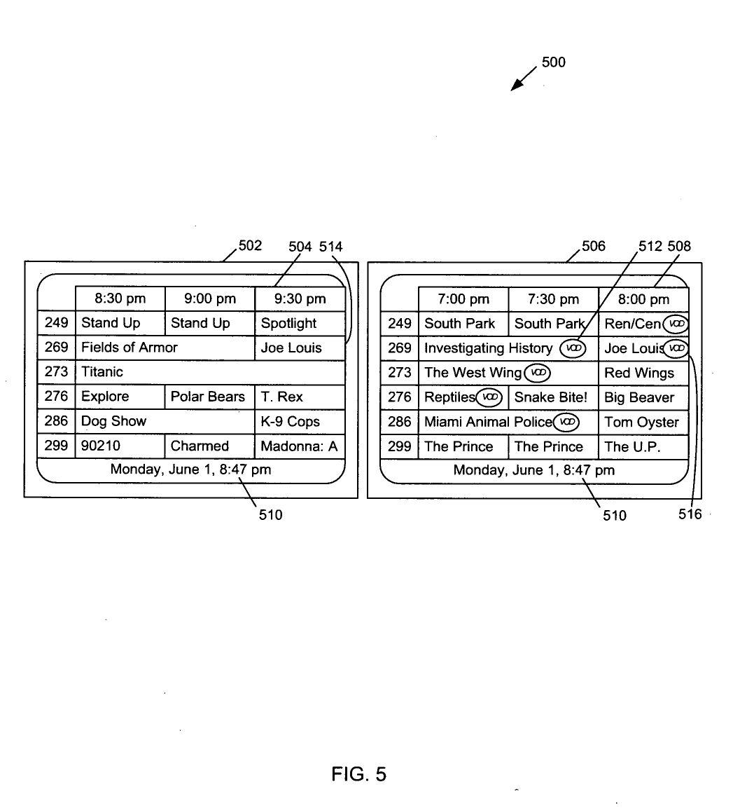

Referring to FIG. 5, a particular illustrative embodiment of a graphical user interface to provide video-on-demand (VOD) content is depicted and generally designated 500. A first program schedule 504 is displayed at a first display device 502. A second program schedule 508 is displayed at a second display device 506.

In a particular embodiment, the first program schedule 504 can be an electronic program guide (EPG) displaying EPG data for current and future scheduled multimedia programs. The current and future scheduled multimedia programs can include television programs that are available at a current time 510 or that will be available at a future time. In an illustrative embodiment, the first program schedule 504 can display information for scheduled multimedia programs that are available from an Internet Protocol Television (IPTV) service provider, such as from the channel content server 104 of FIG. 1.

In a particular embodiment, the second program schedule 508 can be a historical EPG displaying historical EPG data for scheduled multimedia programs that ended prior to the current time 510. The second program schedule 508 can display an indication 512 for each multimedia program that is available from a VOD content provider. In a particular embodiment, the VOD content can be provided by a separate multimedia service provider than the scheduled multimedia programming, such as from the VOD server 110 of FIG. 1.

In an illustrative embodiment, the indication 512 can include an icon, an image, a video clip, an audible indicator such as a distinctive tone that is played when a user navigates to the program indicator, a color, a font type, a shading or contrast scheme, any other indication to distinguish a program that is available from the VOD content provider from a program that is not available from the VOD content provider, or any combination thereof. In a particular embodiment, the first program schedule 504 may not display the indication 512 for a program 514 that is available as VOD content before the scheduled program time, while the second program schedule may display the indication 512 for the same program 516 after the scheduled program time.

Although the particular illustrative embodiment depicted in FIG. 5 shows the first program schedule 504 displayed at the first display device 502 and the second program schedule 508 displayed at the second display device 506, in another particular embodiment the first program schedule 504 and the second program schedule 508 can be displayed at a single display device. In an illustrative embodiment, when a user commands a set-top box device (STB) to display program guide information at a display device, such as via pressing an EPG button at a remote control device, the STB can send the first program schedule 504 showing current and future programming to the display device. The STB can send the second program schedule 508 to the display device in response to another instruction, such as an instruction generated by a user pressing a “back” button or a left arrow button when the first program schedule 504 is displayed, an instruction generated by a user pressing a dedicated hotkey or shortcut button on the remote control device, any other instruction to display the second program schedule 508, or any combination thereof.

In a particular embodiment, the first program schedule 504 and the second program schedule 508 are navigable and selectable by a user via navigation and selection commands-that are received in response to a user pressing navigation buttons or arrow keys of a STB, a remote control device, or any combination thereof. In an illustrative embodiment, navigation and selection commands can be received via other user input devices, such as a speech interface, a pointing device, a text or numerical instruction entered via a keyboard or keypad, any other user input device, or any combination thereof.

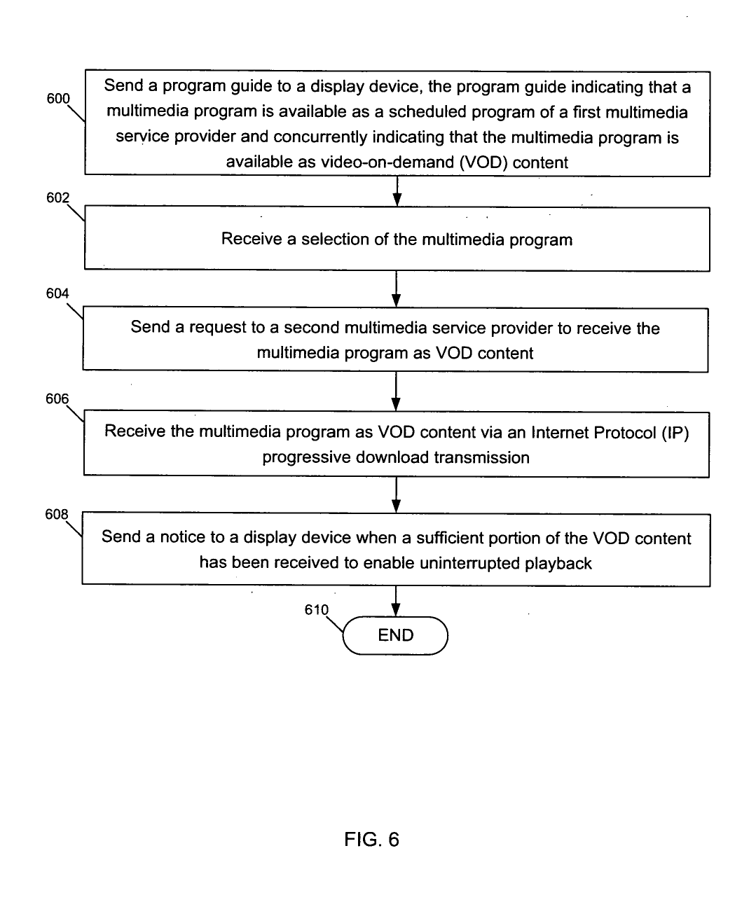

Referring to FIG. 6, a flow diagram of a third particular illustrative embodiment of a method of distributing video-on-demand (VOD) content is depicted. At block 600, a program guide is sent to a display device, the program guide indicating that a multimedia program is available as a scheduled program of a first multimedia service provider and concurrently indicating that the multimedia program is available as video-on-demand (VOD) content. In a particular embodiment, the program guide indicates that the multimedia program is available as VOD content when the scheduled program has ended but does not indicate that the multimedia program is available as VOD content when the scheduled program has not ended.

Moving to block 602, a selection of the multimedia program is received. Continuing to block 604, a request is sent to a second multimedia service provider to receive the multimedia program as VOD content. In an illustrative embodiment, the request can be sent to a VOD server of a second multimedia service provider. In another illustrative embodiment, the request can be sent to a channel content guide server of the first multimedia service provider.

Proceeding to block 606, in a particular embodiment, the multimedia program is received as VOD content via an Internet Protocol (IP) progressive download transmission. Moving to block 608, in a particular embodiment, a notice is sent to a display device when a sufficient portion of the VOD content has been received to enable uninterrupted playback. The method terminates at 610.

In conjunction with the configuration of structure described herein, the systems and methods disclosed provide video-on-demand (VOD) content. In a particular embodiment, a channel content guide server can receive program scheduling data from channel content server. The program scheduling data can identify a first set of multimedia programs that are available from a first multimedia service provider and associated program schedule times. The channel content guide server can also receive video-on-demand (VOD) availability data from a VOD server. The VOD availability data can identify a second set of multimedia programs that are accessible as VOD content from a second multimedia service provider. The channel content server can identify one or more multimedia programs that are in both the first set and the second set, and store program guide data that associates the identified multimedia programs with the program schedule time and also with a VOD indicator.

The channel content guide server can provide program guide information to a multimedia receiver, such as a set-top box device (STB). The STB can display an electronic program guide (EPG) in response to receiving a command from a user, such as a selection of an EPG button at a remote control device. The EPG can include a first program schedule that displays current and future scheduled programming available from the first multimedia service provider. The EPG can also include a second program schedule that displays past scheduled programming of the first multimedia service provider and indicates VOD accessibility for each program that is available from the second multimedia content provider.

The STB can receive a program selection from the user, verify that the selected program complies with parental control policies established for the users of the STB, and can send program selection data to the channel content guide server that identifies the selected multimedia program and the selected program schedule time. The channel content guide server can receive the program selection data and, if the selection is received after the scheduled program time, send an instruction to the VOD server to provide the selected program as VOD content as IP unicast transmission.

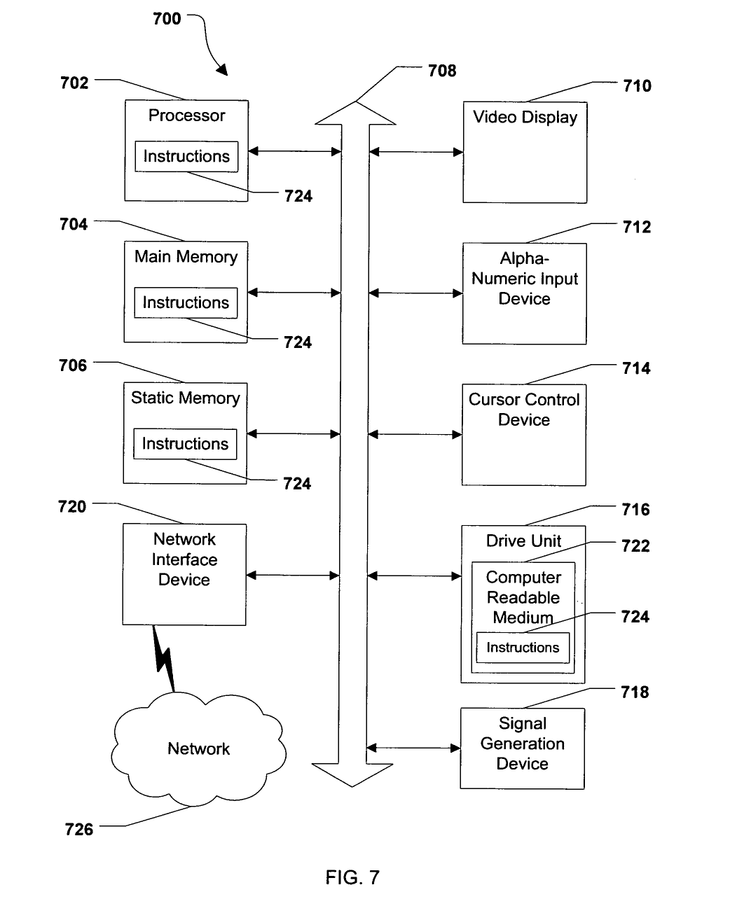

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a video server or application server, or a set-top box device. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the, instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing video-on-demand content, the method comprising:
receiving video-on-demand (VOD) availability data at a server of a first multimedia service provider, the VOD availability data identifying a multimedia program available from a second multimedia service provider as VOD content; and
sending program guide data to a multimedia receiver, wherein the program guide data causes the multimedia receiver to display an indication that the multimedia program is available as VOD content concurrently with displaying an indication that the multimedia program is available as a scheduled program of the first multimedia service provider.

2. The method of claim 1, wherein the program guide data includes current and future programming information to display a first program schedule at the multimedia receiver, and wherein the program guide data further includes historical programming information to display a second program schedule at the multimedia receiver.

3. The method of claim 1, further comprising:
receiving program scheduling data that identifies the multimedia program as a scheduled program of the first multimedia service provider;
determining that the multimedia program is identified by the VOD availability data and also identified by the program scheduling data; and
storing VOD indicator data to indicate that the multimedia program is available as VOD content.

4. The method of claim 1, wherein the multimedia program is indicated as available as VOD content after a scheduled program time of the multimedia program but is not indicated as available as VOD content before the scheduled program time.

5. The method of claim 1, further comprising receiving a selection of the multimedia program from the multimedia receiver, wherein the selection is received after a scheduled program time of the multimedia program.

6. The method of claim 5, further comprising sending VOD content charge data to the multimedia receiver, wherein the VOD content charge data causes the multimedia receiver to indicate a charge to receive the multimedia program as VOD content.

7. The method of claim 6, further comprising receiving an acceptance of the charge from the multimedia receiver.

8. The method of claim 1, further comprising sending an instruction to the second multimedia service provider to provide the multimedia program to the multimedia receiver as VOD content.

9. The method of claim 8, further comprising sending a message to the multimedia receiver indicating the multimedia program is ready to play at the multimedia receiver.

10. The method of claim 1, wherein the first multimedia service provider is an Internet Protocol Television (IPTV) service provider that uses Internet Protocol (IP) multicast to provide scheduled program content, and wherein the second multimedia service provider uses IP unicast to provide VOD content.

11. A method of providing video-on-demand content, the method comprising:
sending a program guide to a display device, the program guide indicating that a multimedia program is available as a scheduled program of a first multimedia service provider and concurrently indicating that the multimedia program is available as video-on-demand (VOD) content;
receiving a selection of the multimedia program; and
sending a request to a second multimedia service provider to receive the multimedia program as VOD content.

12. The method of claim 11, further comprising receiving the multimedia program as VOD content via an Internet Protocol (IP) progressive download transmission.

13. The method of claim 12, further comprising sending a notice to a display device when a sufficient portion of the VOD content has been received to enable uninterrupted playback.

14. The method of claim 11, wherein the program guide indicates that the multimedia program is available as VOD content when the scheduled program has ended but does not indicate that the multimedia program is available as VOD content when the scheduled program has not ended.

15. A system to provide video-on-demand content, the system comprising:
a server to provide video-on-demand content to a first multimedia service provider from a second multimedia service provider, the server having a processor and a memory device accessible to the processor;
wherein the memory device includes instructions to send data identifying a plurality of multimedia programs to a channel content guide server of the first multimedia service provider, wherein a first multimedia program of the plurality of multimedia programs is distributed by the first multimedia service provider as a scheduled program; and
wherein the memory device includes instructions to receive a request from the channel content guide server to provide the first multimedia program as video-on-demand (VOD) content to a set-top box device (STB), wherein the request is received in response to a selection of the first multimedia program at the STB after the scheduled program has ended.

16. The system of claim 15, wherein the memory device includes instructions to provide the first multimedia program as VOD content to the STB.

17. The system of claim 16, wherein the memory device includes instructions to provide the first multimedia program to the STB via an Internet Protocol (IP) network of the first multimedia provider.

18. The system of claim 17, wherein the memory device includes instructions to provide the first multimedia program to the STB via a cache server that is coupled to the IP network.

19. The system of claim 17, wherein the memory device includes instructions to stream the first multimedia program to the STB.

20. A processor-readable medium tangibly embodying processor instructions to:
receive program scheduling data from a channel content server, the program scheduling data identifying a first plurality of multimedia programs and associated program schedule times;
receive video-on-demand (VOD) availability data from a VOD server, the VOD availability data identifying a second plurality of multimedia programs that are accessible as VOD content;
identify a multimedia program that is in the first plurality of multimedia programs and that is also in the second plurality of multimedia programs; and
store program guide data associating the multimedia program with the associated program schedule time and also associating the multimedia program with a VOD indicator.

21. The processor-readable medium of claim 20, wherein the first plurality of multimedia programs are made available to a first set of subscribers by a first multimedia service provider, and wherein the second plurality of multimedia files are provided by a second multimedia service provider that does not provide scheduled multimedia programming to the first set of subscribers.

22. The processor-readable medium of claim 21, wherein the processor instructions include instructions to:
receive program selection data from a set-top box device (STB), the program selection data indicating a selection of the multimedia program and an associated program schedule time at the STB; and
send an instruction to the VOD server to provide the multimedia program to the STB as VOD content.

23. A set-top box device comprising:
a processor and a memory device coupled to the processor;
wherein the memory device includes instructions to display a graphical user interface (GUI), the GUI including a first program schedule that displays current and future scheduled programming available from a first multimedia service provider, the GUI including a second program schedule that displays past scheduled programming of the first multimedia service provider, wherein each program displayed in the second program schedule indicates video-on-demand (VOD) accessibility when the program is available as VOD content from a second multimedia service provider.

24. The set-top box device of claim 23, wherein the first program schedule displays a current time period and a plurality of future time periods, wherein the displayed time periods are navigable by a user of the STB via navigation commands received at the STB, and wherein the second program schedule is displayed when a navigation command to navigate to a time period before the current time period is received at the STB.

25. The set-top box device of claim 24, wherein the navigation command is a left-arrow signal received from a remote control device when a navigation cursor displayed at the first program schedule indicates the current time period.
